(19) United States
(12) Patent Application Publication
(10) Pub. No.: US 2014/0188256 A1
(43) Pub. Date: Jul. 3, 2014

(54) COMMUNICATION DEVICE AND METHOD FOR CONTROLLING ELECTRONIC DEVICES

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: JIE LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/135,679

(22) Filed: Dec. 20, 2013

(30) Foreign Application Priority Data
Dec. 28, 2012 (CN) 2012105868257

(51) Int. Cl. G05B 15/02

(52) U.S. Cl. CPC G05B 15/02
USPC 700/90

(57) ABSTRACT

In a method of controlling electronic devices, a communication device communicates with one or more electronic devices and a cloud server in a communication network. The communication device searches the one or more electronic devices in the communication network and sets a control rule list. The control rule list includes identification information of the one or more electronic devices, and control commands and control times for the one or more second electronic devices. The communication device uploads the identification information of the one or more electronic devices and the control rule list to the cloud server. The cloud server sends the control rule list to the one or more electronic devices according to the identification information. Then, each of the one or more electronic devices is controlled by executing the control commands in the control rule list when corresponding control times reach.

### BACKGROUND

1. Technical Field

Embodiments of the present disclosure relate to device controlling technology, and more particularly to, electronic devices remote controlling method using a communication device.

2. Description of Related Art

Electronic devices, such as, smart phones, tablet personal computers, are popular. There are various functions installed in the electronic devices, such as video playing, games, instant messaging, and social networks. Thus, most people spend more and more time on the electronic devices, for example, when eating, when having a meeting, even when attending classes. How to “drag” people away from their electronic devices is a problem. Therefore, there is room for improvement in the art.

### BRIEF DESCRIPTION OF THE DRAWINGS

FIG. 1 is a block diagram of one embodiment of hardware configuration of an electronic device control system.

FIG. 2 is a block diagram of one embodiment of function modules of electronic device control system.

FIG. 3 is a flowchart of embodiments of a method for controlling electronic device using a communication device.

FIG. 4 is a table of a control rules list.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processers. The modules described herein may be implemented as either software and/or hardware modules and may be stored in any type of non-transitory computer-readable storage medium or other computer storage device.

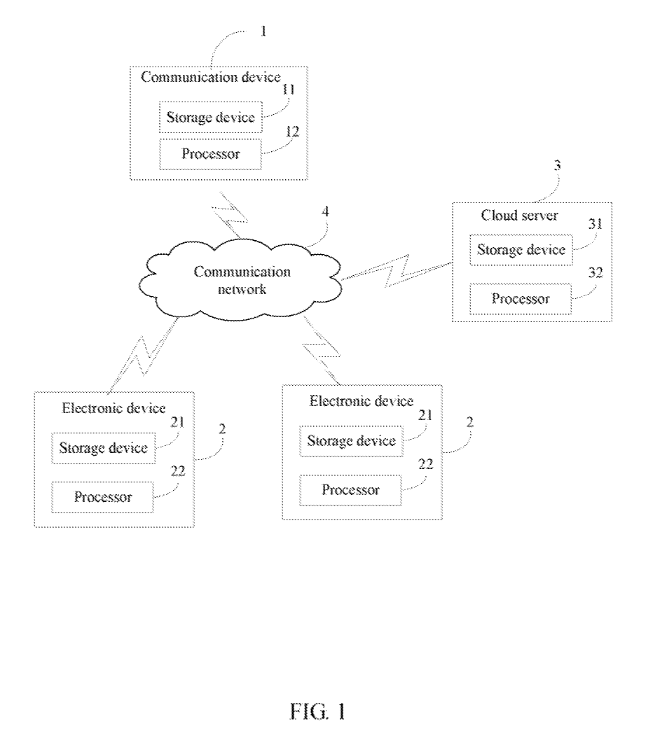

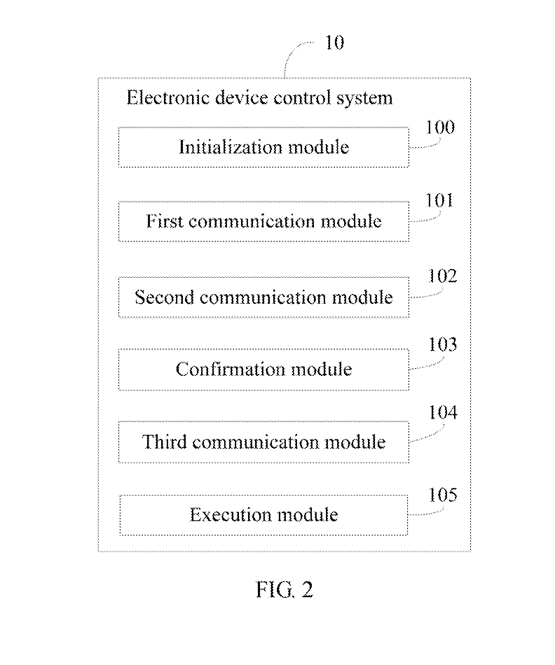

FIG. 1 is a block diagram of one embodiment of hardware configuration of an electronic device controlling system. The hardware configuration of an electronic device control system 10 (shown on FIG. 2) comprises one communication device 1, one or more electronic devices 2, and a cloud server 3. The communication device 1, the one or more electronic devices 2, and the cloud server 3 communicating with each other use a communication network 4. The communication device 1 and the one or more electronic devices 2 may be a smart phone, a portable computer, or a tablet personal computer, for example. The communication network 4 may be an intranet or the Internet.

The communication device 1 comprises a storage device 11 and a processor 12. Each of the electronic devices 2 comprises a storage device 21 and a processor 22. The cloud server 3 comprises a storage device 31 and a processor 32. One skilled in the art would recognize that the communication device 1, each of the electronic devices 2 and the cloud server 3 may be configured in a number of other ways and may include other or different components.

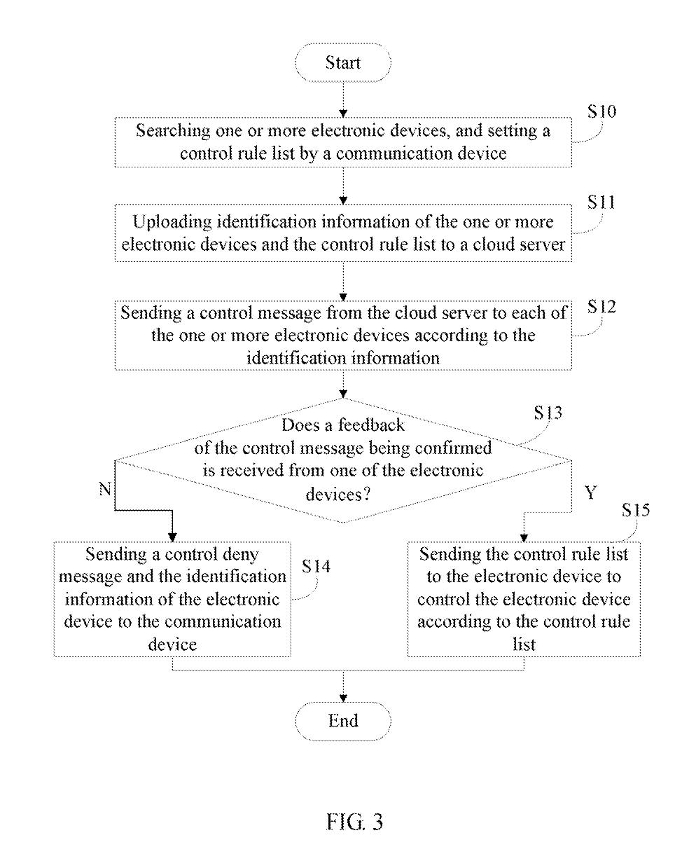

FIG. 2 is a block diagram of one embodiment of function modules of the electronic device control system 10. The electronic device control system 10 may comprise an initialization module 100, a first communication module 101, a second communication module 102, a confirmation module 103, a third communication module 104, and an execution module 105. In one embodiment, the initialization module 100 and the first communication module 100 are installed and running in the communication device 1. The second communication module 102 is installed and running in the cloud server 3. The confirmation module 103, the third communication module 104, and the execution module 105 are installed and running in each of the one or more electronic devices 2. The function module 100-105 comprises computerized codes in the form of one or more programs, which are stored in a storage device, such as the storage device 11 of the communication device 1, the storage device 21 of each of the one or more electronic devices 2, and/or the storage device 31 of the cloud server 3, and perform functions, such as, control to lock or unlock the one or more electronic device 2 when executed by a processor, such as the processor 12 of the communication device 1, the processor 22 of each of the one or more electronic devices 2, and/or the processor 32 of the cloud server 3. Details of the functions of the function modules 100-105 are described with reference to FIG. 3.

FIG. 3 is a flowchart of embodiments of a method of controlling the electronic devices 2 using the communication device 1. Depending on the embodiment, additional steps in FIG. 3 may be added, others removed, and the ordering of the steps may be changed.

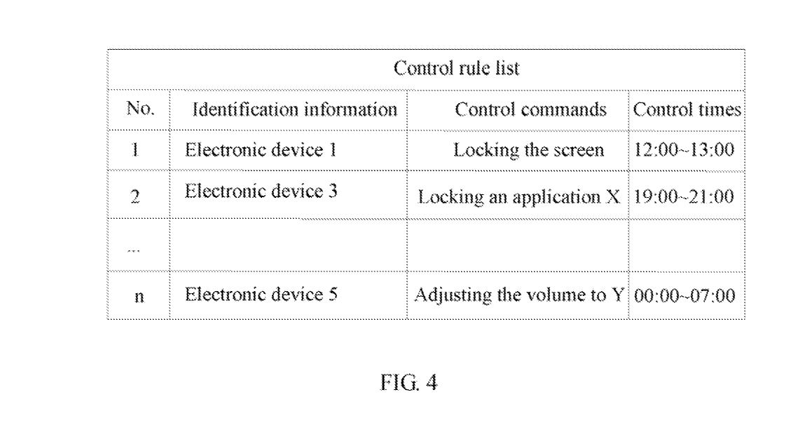

In step S10, the initialization module 100 searches one or more electronic devices 2 on the communication network 4, and sets a control rule list and stores the control rule list in the storage device 11 of the communication device 1. FIG. 4 shows a schematic diagram of the control rule list. The control rule list comprises identification information of the one or more electronic devices 2, and control commands and control times for the one or more electronic devices 2. As illustrated, the control commands may comprise locking a screen of one of the electronic devices 2, locking an application installed in one of the electronic devices 2, and adjusting a volume of one of the electronic devices 2, and so on.

In step S11, the first communication module 101 of the communication device 1 uploads the identification information of the one or more electronic devices 2 and the control rule list to the cloud server 3.

In step S12, the second communication module 102 of the cloud server 3 receives the identification information of the one or more electronic devices 2 and the control rule list from the communication device 1, and sends a control message to each of the one or more electronic devices 2 according to the identification information. In one embodiment, the control message may be “agree to be controlled by the communication device?”

In step S13, the second communication module 102 determines if a feedback of the control message being confirmed is received from one of the electronic devices 2. In one embodiment, the third communication module 104 of one of the electronic devices 2 receives the control message from the cloud server 3, and the confirmation module 103 of the electronic device 2 determines whether the control message is confirmed or not. In one embodiment, the confirmation module 103 outputs a confirmation option and a deny option on the screen of the electronic device 2. When the user selects the confirmation option, the confirmation module 103 determines that the control message is confirmed, then, the third communication module 104 sends the feedback of the control message is confirmed to the cloud server 3, and step S15 is implemented. When the user selects the deny option, the confirmation module 103 determines that the control message is not confirmed, then no feedback is sent to the cloud server 3, and then step S14 is implemented. In other embodiment, when neither the confirmation option nor the deny option is selected by the user, it is defaulted that the control message is confirmed, then the third communication module 104 sends the feedback of the control message is confirmed to the cloud server 3.

In step S14, the second communication module 102 of the cloud server 3 sends a control deny message and the identification information of the electronic device 2 to the communication device 1.

In step S15, the second communication module 102 of the cloud server 3 sends the control rule list to the electronic device 2 to control the electronic device 2 according to the remote control rule. In one embodiment, the execution module 105 of the electronic device 2 executes the control commands in the control rule list when corresponding control times reaches. For example, when it is time of 19:00, the execution module 105 locks the application X installed in the electronic device 2 until 21:00.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A communication device, which controls electronic devices through a cloud server, comprising:
a storage device;
at least one processor; and
one or more modules that are stored in the storage device and executed by the at least one processor, the one or more modules comprising instructions to:
search one or more electronic devices on a communication network, and set a control rule list by the communication device, wherein the control rule list comprises identification information of the one or more electronic devices, and control commands and control times for the one or more electronic devices; and
upload the identification information of the one or more electronic devices and the control rule list to the cloud server, and send the control rule list from the cloud server to the one or more electronic devices, for controlling the one or more electronic devices according to the identification information.

2. The communication device according to claim 1, wherein the cloud server sends a control message to each of the one or more electronic devices according to the identification information, and sends the control rules list to the electronic devices from which a feedback of the control message being confirmed is received.

3. The communication device according to claim 1, wherein the cloud server sends a control deny message and the identification information of the electronic devices from which a feedback of the control message being confirmed is not received to the electronic device.

4. The electronic device according to claim 1, wherein the control commands comprise locking screens of the one or more electronic devices, locking applications installed in the one or more electronic devices, and adjusting volumes of the one or more electronic devices.

5. A method of controlling electronic devices using a communication device, the communication device communicating with a cloud server through a communication network, comprising:
searching one or more electronic devices on the communication network, and setting a control rule list by the communication device, wherein the control rule list comprises identification information of the one or more electronic devices, and control commands and control times for the one or more electronic devices; and
uploading the identification information of the one or more electronic devices and the control rule list to the cloud server;
sending the control rule list from the cloud server to the one or more electronic devices according to the identification information; and
executing the control commands in the control rule list to control each of the one or more electronic devices when the corresponding control times reach.

6. The method according to claim 5, wherein the sending step comprises:
sending a control message to each of the one or more electronic devices according to the identification information; and
sending the control rule list to the electronic devices from which a feedback of the control message being confirmed is received.

7. The method according to claim 5, wherein the sending step comprises:
sending a control deny message and the identification information of the electronic devices from which a feedback of the control message being confirmed is not received to the communication device.

8. The method according to claim 5, wherein the control commands comprise locking screens of the one or more electronic devices, locking applications installed in the one or more electronic devices, and adjusting volumes of the one or more electronic devices.

9. A non-transitory storage medium having stored thereon instructions that, when executed by processers of a communication device, causes the communication device to perform a method of controlling electronic devices, the communication device communicating with a cloud server through a communication network, wherein the method comprises:
searching one or more electronic devices on the communication network, and setting a control rule list by the communication device, wherein the control rule list comprises identification information of the one or more electronic devices, and control commands and control times for the one or more electronic devices; and
uploading the identification information of the one or more electronic devices and the control rule list to the cloud server;
sending the control rule list from the cloud server to the one or more electronic devices according to the identification information by the cloud server; and
executing the control commands in the control rule list to control each of the one or more electronic devices when corresponding control times reach.

10. The non-transitory storage medium according to claim 9, wherein the sending step comprises:
sending a control message to each of the one or more electronic devices according to the identification information; and
sending the control rule list to the electronic devices from which a feedback of the control message being confirmed is received.

11. The non-transitory storage medium according to claim 9, wherein the sending step comprises:
sending a control deny message and the identification information of the electronic devices from which a feedback of the control message being confirmed is not received to the communication device.

12. The non-transitory storage medium according to claim 9, wherein the control commands comprise locking screens of the one or more electronic devices, locking applications installed in the one or more electronic devices, and adjusting volumes of the one or more electronic devices.
